(19) United States
(12) Patent Application Publication
(10) Pub. No.: US 2004/0114658 A1
(43) Pub. Date: Jun. 17, 2004

(54) Laser structure and method for adjusting a defined wavelength

(76) Inventor: Bernhard Stegmuller, Augsburg (DE)

Correspondence Address: Jeffrey R Stone, Briggs & Morgan, 2200 IDS Center, 80 South Eighth Street, Minneapolis, MN, 55402, US

(21) Appl. No.: 10/467,191

(22) PCT Filed: Jan. 25, 2002
(86) PCT No.: PCT/DE02/00259

(30) Foreign Application Priority Data
Feb. 8, 2001 (DE) 101 05 731.8

(51) Int. Cl. H01S 3/082

(52) U.S. Cl. 372/97

(57) ABSTRACT

The present invention relates to a laser structure (100) on a semiconductor substrate which comprises a first resonator (110), a second resonator (120) and a third resonator (130). The second resonator (120) and the third resonator (130) are designed as ring resonators and are arranged in at least one common section next to the first resonator (110) or next to the second resonator (120), respectively, substantially at a constant spacing from the first resonator (110) or from the second resonator (120), respectively. As a result, the second resonator (120) is optically coupled to the first resonator (110), and the third resonator (130) is optically coupled to the first resonator (110) via the second resonator (120) or directly, respectively, in such a way that a standing wave with a defined wavelength can form in the first resonator (110).

The present invention relates to a laser structure and a method for setting a defined wavelength.

A laser diode with a settable narrow-band emission wavelength is a key component in the optical signal transmission technology and in the optical signal processing technology. The setting of a defined emission wavelength and the coupling of various signals of different wavelengths (so-called “carrier frequencies”) are necessary in order to be able to achieve an extremely high data transmission rate of greater than 1 Tbit/s.

A laser diode is known in which the wavelength is selected by means of a distributed feedback structure or a distributed Bragg reflector structure. In the case of such a structure, a light wave is generated and guided in a light-guiding strip or film which at the same time is the active region. The guidance along the film is effected by differences in the refractive indices between the core region and the cladding region. In accordance with the Bragg condition a periodic variation in the thickness of the core region leads to light scattering as well as to interference of a portion of the generated wavelengths.

In a distributed Bragg reflector structure, the periodic variation in the core region thickness at the end regions of the active optical film is used instead of resonator mirrors, as a result of which the light of a specific wavelength can be specifically selected by reflection and then amplified.

In a distributed feedback structure, however, the periodic variation in the core region thickness is propagated along the entire active optical film, as a result of which an optical excitation happens specifically only at a specific wavelength.

The setting of the laser wavelength is mostly performed by tuning the resonance wavelength in the laser resonator by physical action. For example, the resonance wavelength can be influenced by means of the current flow through the active optical film, by means of the voltage present at the active optical film, or by means of the temperature prevailing in the active optical film.

Alternatively, the setting of the laser wavelength can be performed by optical coupling of various linear individual resonators such that specific wavelengths are preferred. The best known linear individual resonators are the Fabry-Perot resonator, the distributed feedback resonator and the distributed Bragg reflector resonator. The distributed Bragg reflector resonator is a resonator with parallel resonator mirrors which is applied chiefly in the case of surface emitting lasers (VCSEL=vertical cavity surface emitting laser), wherein the resonator mirrors are arranged on the end surfaces of the VCSEL substrate.

Owing to a relatively weak optical coupling between the linear individual resonators, it is necessary for the optical components with the linear individual resonators to extend to several 100 μm. This is the case, in particular, if the waves propagate in the plane of the grown epitaxial layers by means of which the optical components are produced.

JP 04349682 A discloses a light source for optical communication which can control a high light output power over a wide frequency range, or is operated on a single wavelength over a wide range of the optical output power, wherein a semiconductor laser with coupled modes is applied. In this case, a first semiconductor laser section is optically coupled to a second semiconductor laser section by means of a resonator, wherein the first semiconductor laser section is operated with a high output power, and wherein the second semiconductor laser section is operated at a single wavelength. A DFB (distribution feedback) ring laser can be applied as second semiconductor laser section in this case. The two semiconductor laser sections in this case constitute two separate individual resonators.

Two waveguides are optically coupled to one another by means of a ring or disc resonator in Opt. Lett., Vol. 22, No. 16, pp. 1244-1246 (1997). In this case, the ring or disc resonator assumes the function of a switching element by which it is possible to control whether a light signal guided in one waveguide is also transmitted by means of the other waveguide. In this case, however, there is no variable setting of a narrow-band emission wavelength. Reference may also be made to Appl. Phys. Lett., Vol. 66, No. 20, pp. 2608-2610 (1995) as regards the production of a ring resonator.

A combination of optically coupled individual resonators with a physical effect on the resonance frequency of the separate individual resonators certainly renders a narrow-band emission wavelength possible, but leads in the process to a large component size of up to several 0.01 mm². Moreover, the production of separate individual resonators is very complicated, and thus cost intensive. The reason for this in the case of the distributed feedback resonator and the distributed Bragg reflector resonator is the meticulous periodic variation in the core region thickness, and in the case of the Fabry-Perot resonator it is the difficult production of optically highly reflective, parallel mirrors at the resonator ends.

The present invention is therefore based on the problem of specifying a laser structure and a method for setting a defined wavelength by means of which structure/method it is possible to achieve an emission wavelength of narrower bandwidth by comparison with the described prior art despite a smaller component size.

The problem is solved by means of a laser structure as well as by means of a method for setting a defined wavelength having the features in accordance with the independent patent claims.

A laser structure on a semiconductor substrate comprises a first resonator, a second resonator and a third resonator. The second resonator and the third resonator are designed as ring resonators and are arranged in at least one common section next to the first resonator or next to the second resonator, respectively, substantially at a constant spacing from the first resonator or from the second resonator, respectively. Consequently, the second resonator is optically coupled to the first resonator, and the third resonator is optically coupled to the first resonator via the second resonator or directly, respectively, in such a way that a standing wave of a defined wavelength can form in the first resonator.

The common section in which a resonator is arranged next to another resonator substantially at a constant spacing from the other resonator has a length of at least several wavelengths of the emitted laser radiation so as to ensure an adequate overlap of the optical wave functions of the two resonance waves. This overlap influences the resonance frequencies of the two resonators and thereby permits the emitted laser radiation to be set.

The following steps are carried out in a method for setting a defined wavelength: a first resonator is provided in a laser structure on a semiconductor substrate. A ring resonator is arranged as a second resonator in at least one common section next to the first resonator substantially at a constant spacing from the first resonator. A further ring resonator is arranged as a third resonator in at least one common section next to the second resonator or next to the first resonator, respectively, substantially at a constant spacing from the second resonator or from the first resonator, respectively. The second resonator is optically coupled to the first resonator in such a way and the third resonator is optically coupled to the first resonator via the second resonator or directly, respectively, in such a way that a standing wave of a defined wavelength can form in the first resonator.

An advantage of the present invention is that the laser structure according to the present invention comprises a component size of a few 100 μm², preferably a maximum component size of 100 μm², wherein the actual component size depends on the number of resonators, on the desired wavelength and on the materials used for the components. The laser structure according to the present invention is therefore suitable for use in a highly integrated circuit (VLSI circuit=very large scale integration circuit).

A further advantage of the present invention emerges in the case when use is made of ring resonators of different size by nesting them in one another, thus permitting optical coupling of the resonators in a very small space and thereby achieving a further reduction in the component size. Moreover, in the case of an optical coupling of resonators whose resonance wavelengths differ by only a few percent, it is possible to set the desired emission wavelength on the basis of the Nonius effect. Depending on the desired emission wavelength, more or fewer resonators are then coupled to one another optically by means of further resonators acting as switching elements.

Finally, as a further advantage the effort during producing the resonators is reduced when use is made of pure ring resonators in the present invention. The reason for this is that, because distributed feedback resonators and distributed Bragg reflector resonators are dispensed with, there is then no need to produce meticulous periodic variations in the core region thickness and, because Fabry-Perot resonators are dispensed with, there is then no need to produce optically highly reflective, parallel mirrors at the resonator ends. Consequently, the production costs for the optical component are also substantially reduced thereby.

The laser structure according to the present invention is preferably set up in such a way that the third resonator and the second resonator are arranged nested in one another in one plane. For example, the second resonator and the third resonator can be arranged in a first plane, while the second resonator is arranged in a plane parallel to the first plane. Alternatively, the third resonator and the second resonator can also be arranged next to one another in parallel planes.

The laser structure according to the present invention is preferably set up in such a way that the respective optical coupling of the three resonators can be varied by means of at least one external parameter. A laser structure provided in such a way permits the user to be able to influence the defined wavelength in the first resonator. The resonance frequency of the second resonator and of the third resonator can be set in a variable fashion depending on the external parameter. A defined laser wavelength can be set in the first resonator by means of the optical coupling of the second resonator and the third resonator to the first resonator.

The current flow, the temperature and the applied voltage preferably belong to the group of external parameters.

In a preferred embodiment of the laser structure according to the present invention, at least one further ring resonator is optically coupled to the first resonator directly or via one of the other resonators. A higher accuracy in the setting of the defined laser wavelength in the first resonator can be achieved by means of a direct or indirect optical coupling of further resonators to the first resonator.

In a further preferred embodiment of the laser structure according to the present invention, at least one further resonator is arranged adjacent to the three resonators. The further resonator permits control of the respective optical coupling between the individual resonators. For example, the further resonator can be used as a switching element which can switch the optical coupling between the first resonator and the second resonator on and off, and thus influences the setting of the defined laser wavelength in the first resonator.

The laser structure according to the present invention is preferably set up in such a way that the second resonator, the third resonator and each further ring resonator each act as a wavelength filter on the first resonator.

It is preferred in the laser structure according to the present invention for the second resonator, the third resonator and each further resonator to be designed in each case as distributed feedback resonators or as distributed Bragg reflector resonators.

For all resonators, the electrooptically active resonator region consists of a quantum well (QW) structure or a quantum dot (QD) structure made from II-VI-, III-V- or IV-IV-semiconductor materials. The ring resonators can comprise ridge waveguides, buried waveguides and/or photonic crystals in quasi-two-dimensional and quasi-three-dimensional fashion. Parts of the ring resonators, a complete single ring resonator or several ring resonators can also consist of passive waveguides.

It is possible to effect the gain, the absorption, the modulation and the detection in parts of, or in the entire waveguide in the respective resonator via electric contacts by means of charge carrier injection through the current flow, by means of temperature variation owing to heating elements, and by means of the applied voltage through the quantum confined Stark effect. The refractive indices of the waveguide components change with a change in temperature. The associated resonance frequency, and thus the laser wavelength emitted by the laser structure, change in the respective resonator in accordance with the variation undertaken.

The laser structure according to the present invention is based on a substrate in which the laser structure is integrated or onto which the laser structure is grown. II-VI-, III-V- or IV-IV-semiconductor materials can be selected as material for the substrate. The laser structure according to the present invention can be produced by means of conventional production methods for semiconductors. These include, for example, etching, diffusion, doping, epitaxy, implantation and lithography.

The optical coupling of the second resonator to the further resonators can be performed in a nested fashion, that is to say in a space-saving way, wherein the structure of ring resonators is particularly favourable for this purpose. Possible shapes for ring resonators are, for example, circles, ellipses and polygons which are respectively arranged nested in one another in one plane and with different sizes. The geometrical shape of the ring resonators is only of secondary importance in this case as long as each resonator has the shape of a closed ring.

A three-dimensional arrangement of the resonators is likewise possible, that is to say some resonators are arranged adjacently within a plane, while further resonators, which can also be constructed concentrically with the adjacent resonators, are arranged adjacently in a parallel plane. Given equal spacing of the resonators, an optical coupling of resonators in parallel planes is better for epitaxial reasons by at least a factor of 10 than is an optical coupling of resonators within one plane.

Exemplary embodiments of the present invention are illustrated in the figures and explained in more detail below. In this case, identical reference symbols denote identical components.

In the drawing:

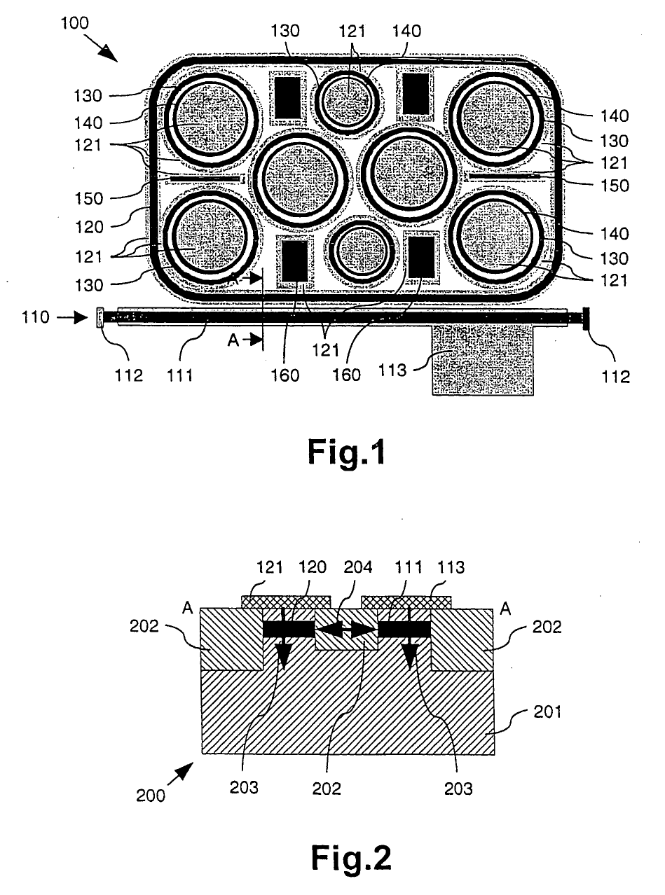

FIG. 1 shows a top view of a laser structure in accordance with a first exemplary embodiment of the present invention;

FIG. 2 shows a cross section through the laser structure from FIG. 1 along the line of section A-A;

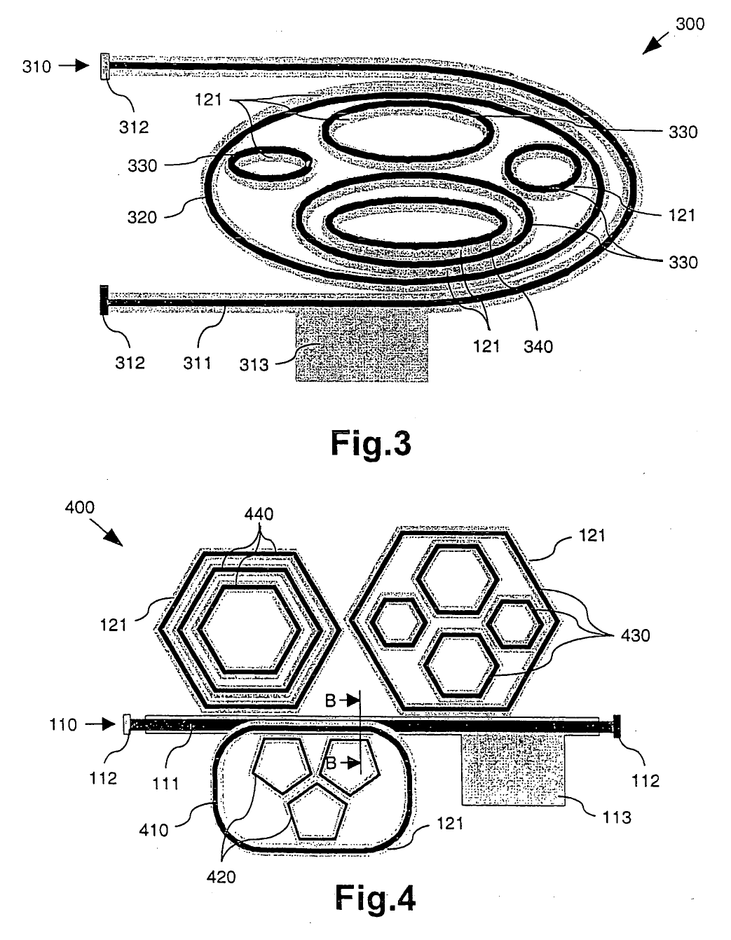

FIG. 3 shows a top view of a laser structure in accordance with a second exemplary embodiment of the present invention;

FIG. 4 shows a top view of a laser structure in accordance with a third exemplary embodiment of the present invention; and

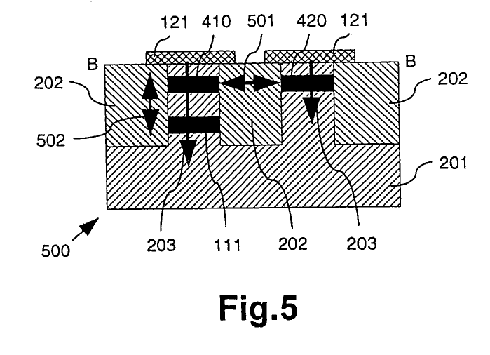

FIG. 5 shows a cross section through the laser structure from FIG. 4 along the line of section B-B.

FIG. 1 shows a top view of a laser structure 100 in accordance with a first exemplary embodiment of the present invention. The laser structure 100 comprises a Fabry-Perot resonator 110 for emitting the laser radiation and in which an active emitter region 111 which is supplied with electric energy via an electric contact 113 is located between two resonator mirrors 112 arranged parallel to one another.

A first ring resonator 120 is optically coupled to the Fabry-Perot resonator 110 for the purpose of setting the emitted laser radiaton. In this exemplary embodiment of the present invention, the first ring resonator 120 has the shape of a rectangle with rounded corners. The first ring resonator 120 is arranged on one of its two longitudinal sides parallel to, and thus at a constant spacing from the Fabry-Perot resonator 110 next to the Fabry-Perot resonator 110, and acts as a wavelength filter on the laser radiation emitted by the Fabry-Perot resonator 110. An electric contact 121 is provided at the first ring resonator 120 for supplying energy to the first ring resonator 120.

In this exemplary embodiment of the present invention, eight second ring resonators 130 each having an electric contact 121 are arranged in the area of the laser structure 100 enclosed by the first ring resonator 120 in such a way that the second ring resonators 130 can interact with one another by optical coupling. This renders possible a setting of the resonance frequency of the second ring resonator 120, and thus a more accurate wavelength setting for the Fabry-Perot resonator 110 emitting laser light.

A third ring resonator 140 with an electric contact 121 is arranged adjacently inside each second ring resonator 130, the third ring resonators 140 having a smaller diameter than the second ring resonators 130. In this case, each third ring resonator 140 optically couples primarily first and foremost with the respective surrounding second ring resonator 130.

Furthermore, two first control resonators 150 and four second control resonators 160 each having an electric contact 121 are arranged in the area of the laser structure 100 enclosed by the first ring resonator 120 in such a way that the optical coupling of the individual ring resonators can be switched on and off among one another. This renders possible an accurate setting of the resonance frequency in the first ring resonator 120, and therefore of a narrow-band emission wavelength for the overall laser structure 100.

In order to explain the arrangement of the laser structure 100, FIG. 2 shows a cross section 200 through the laser structure 100, shown in FIG. 1, along the line of section A-A. It is clear from the cross section 200 that the laser structure 100 is based on a substrate 201.

Also illustrated is one cross section each through the active resonator region 111 of the Fabry-Perot resonator 110 and through the first ring resonator 120. The two resonators are arranged adjacently in a plane parallel to the surface of the substrate 201 and electrically insulated from one another and from the surroundings by insulation material 202. A dielectric material can be selected as insulation material 202. Alternatively, it is also possible to dispense entirely with the insulation material 202, for which reason insulation is then to be effected by air.

The two resonators are supplied with electric energy by the electric contacts 113 and 121, the resonators being flowed through transversely by the electric energy flow 203. The two resonators illustrated have a width of up to 20 μm and a spacing of up to 5 μm from one another.

The optical coupling of the resonators is performed on the basis of an optical overlap between the two resonance wavelengths, as a result of which an optical energy flow 204 is rendered possible between the two resonators.

FIG. 3 shows a top view of a laser structure 300 in accordance with a second exemplary embodiment of the present invention.

In contrast to the laser structure 100 in accordance with the first exemplary embodiment of the present invention, the laser light is emitted from the laser structure 300 in accordance with the second exemplary embodiment of the present invention by a curved resonator 310 with an active resonator region 311, resonator mirrors 312 and an electric contact 313.

Second ring resonators 330 of lesser size are arranged inside the first ring resonator 320, a third ring resonator 340 being arranged nested in one of the two ring resonators 330.

The ring resonators in this exemplary embodiment have an elliptical shape so as to create a possibility of optical coupling between the first ring resonator 320, the second ring resonators 330 and the third ring resonator 340, as well as chiefly to create a possibility of optical coupling to the curved resonator 310. The ring resonators are therefore arranged in each case next to one another among one another as well as in relation to the curved resonator 310 substantially at a constant spacing from one another, at least in a common section.

Owing to the nesting of the ring resonators, just like the laser structure 100 in accordance with the first exemplary embodiment of the present invention, the laser structure 300 in accordance with the second exemplary embodiment of the present invention comprises a low space requirement on a semiconductor substrate.

A top view of a laser structure 400 in accordance with a third exemplary embodiment of the present invention is shown in FIG. 4.

The components already described in FIG. 1 will not be considered in detail again here.

The laser structure 400 of this exemplary embodiment of the present invention differs from the laser structure 100 in accordance with the first exemplary embodiment of the present invention by means of the following features:

The first ring resonator 410 with the nested second ring resonators 420 is arranged adjacently in a plane parallel to the plane of the Fabry-Perot resonator 110. Reference may be made to FIG. 5 for an explanation.

A group of third ring resonators 430 nested in one another, and a group of fourth ring resonators 440 nested in one another are optically coupled directly to the Fabry-Perot resonator 110 in addition to the first ring resonator 410.

The second ring resonators 420, the third ring resonators 430 and the fourth ring resonators 440 have the shape of hexagons.

FIG. 5 shows a cross section 500 through the laser structure 400 shown in FIG. 4 along the line of section B-B. It is chiefly the arrangement of the resonators in several planes that is clear in this illustration.

The components already described in the preceding figures will not be considered again here.

Owing to the arrangement of the resonators in several parallel planes, there is, on the one hand, an optical coupling of the resonators within a plane,, thus permitting a horizontal optical energy flow 501 between the first ring resonator 410 and the second ring resonator 420, and, on the other hand, an optical coupling of the resonators between adjacent planes, thus permitting a vertical optical energy flow 502 between the active resonator region 111 of the Fabry-Perot resonator 110 and the first ring resonator 410.

The emitted laser wavelength thus results from a mixture of the individual optical couplings to the emitting resonator, that is to say a multiple overlap of the optical wave functions of the resonance waves of the various resonators.

1. Laser structure on a semiconductor substrate,
comprising a first resonator, a second resonator, a third resonator, and at least one further resonator,
wherein the second resonator and the third resonator are designed as ring resonators,
wherein the second resonator is arranged in at least one common section next to the first resonator substantially at a constant spacing from the first resonator,
wherein the third resonator is arranged in at least one common section next to the second resonator or next to the first resonator, respectively, substantially at a constant spacing from the second resonator or from the first resonator, respectively,
as a result of which the second resonator is optically coupled to the first resonator, and the third resonator is optically coupled to the first resonator via the second resonator or directly, respectively, in such a way that a standing wave with a defined wavelength can form in the first resonator, and
wherein the at least one further resonator is arranged adjacent to the three resonators,
as a result of which the at least one further resonator permits control of the respective optical coupling between the first resonator, the second resonator and the third resonator.

2. Laser structure according to claim 1, wherein the third resonator and the second resonator are arranged nested in one another in one plane.

3. Laser structure according to claim 1, wherein the third resonator and the second resonator are arranged next to one another in parallel planes.

4. Laser structure according to claim 2, wherein the second resonator and the third resonator are arranged in a first plane, and wherein the first resonator is arranged in a plane parallel to the first plane.

5. Laser structure according to one of the claims 1 to 4, wherein the respective optical coupling of the three resonators can be varied by means of at least one external parameter, as a result of which influence can be exerted on the defined wavelength in the first resonator.

6. Laser structure according to claim 5, wherein the current flow, the temperature and the applied voltage belong to the group of the external parameters.

7. Laser structure according to one of the claims 1 to 6, wherein at least one further ring resonator is optically coupled to the first resonator directly or via one of the other resonators.

8. Laser structure according to one of the claims 1 to 7, wherein the second resonator, the third resonator and each further ring resonator are set up in each case as a wavelength filter acting on the first resonator.

9. Laser structure according to one of the claims 1 to 8, wherein the second resonator, the third resonator and each further resonator are designed in each case as a distributed feedback resonator or as a distributed Bragg reflector resonator.

10. Method for setting a defined wavelength, comprising the following steps:
providing a first resonator in a laser structure on a semiconductor substrate,
arranging a ring resonator as second resonator in at least one common section next to the first resonator substantially at a constant spacing from the first resonator,
arranging a further ring resonator as third resonator in at least one common section next to the second resonator or next to the first resonator, respectively, substantially at a constant spacing from the second resonator or from the first resonator, respectively, and
arranging at least one further ring resonator adjacent to the first resonator, the second resonator and the third resonator,
optically coupling the second resonator to the first resonator and optically coupling the third resonator to the first resonator via the second resonator or directly, respectively, in such a way that a standing wave with a defined wavelength can form in the first resonator, and
using at least one further resonator for controlling the respective optical coupling between the first resonator, the second resonator and the third resonator.
